(19) United States
(12) Patent Application Publication
(10) Pub. No.: US 2010/0077145 A1
(43) Pub. Date: Mar. 25, 2010

(54) METHOD AND SYSTEM FOR PARALLEL EXECUTION OF MEMORY INSTRUCTIONS IN AN IN-ORDER PROCESSOR

(76) Inventors: Sebastian C. Winkel, San Jose, CA (US); Kalyan Muthukumar, Bangalore (IN); Don C. Soltis, JR., Windsor, CO (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/238,341

(22) Filed: Sep. 25, 2008

(51) Int. Cl. G06F 12/08; G06F 9/30

(52) U.S. Cl. 711/125; 712/226; 711/E12.02; 712/E09.028; 712/E09.023

(57) ABSTRACT

A method of parallel execution of a first and a second instruction in an in-order processor. Embodiments of the invention enable parallel execution of memory instructions that are stalled by cache memory misses. The in-order processor processes cache memory misses of instructions in parallel by overlapping the first cache memory miss with cache memory misses that occur after the first cache memory miss. Memory-level parallelism in the in-order processor can be increased when more parallel and outstanding cache memory misses are generated.

### FIELD OF THE INVENTION

This invention relates to an in-order processor, and more specifically but not exclusively, to parallel execution of memory instructions in an in-order processor.

### BACKGROUND DESCRIPTION

An in-order processor such as an Intel® Itanium® processor combines a wide-issue in-order execution core with a non-blocking, and out-of-order memory subsystem. During normal processing of instructions, the in-order processor fetches instructions and determines for each instruction if the input operand(s) of the instruction such as a source register is available. If the input operand(s) is available, the instruction is executed. If the input operand(s) is not available, the in-order processor stalls until the input operand(s) is available.

One example when the input operand(s) is not available is during a cache memory miss. A cache memory miss occurs when the in-order processor tries to retrieve the contents of the memory location pointed to by the memory address in the input operand(s) of a load instruction from the cache memory and the required contents are not available in the cache memory. On a cache memory miss, the execution pipeline of the in-order processor stalls on the first use of the output operand(s) of the load instruction until the required contents of the memory location pointed to by the memory address in the input operand(s) is retrieved from the cache memory and the input operand(s) becomes available. The in-order processor blocks the execution of the current and later instruction groups in the code sequence. Unlike an out-of-order processor, the in-order processor cannot “run ahead” and execute further memory instructions beyond the stall point.

FIG. 1 illustrates an example of a code sequence 100 for an in-order processor. Instructions 1 and 2 are executed in parallel at processor cycle 1. Instruction 1 is a load instruction that loads the contents of the memory location pointed to by the memory address in register v1 to register v2. The in-order processor attempts to locate the contents of the memory location pointed to by the memory address in register v1 in the cache memory but the contents are not available in the cache memory. A cache memory miss occurs and the in-order processor retrieves the contents of the memory location pointed to by the memory address in register v1 from other sources such as the main memory, page tables, or mass storage device for example. Instructions 3 and 4 are stalled because of the cache memory miss of instruction 1 and the in-order processor is not allowed to “run ahead” and execute other instructions until instruction 1 is completed. After a number of processor cycles, in this example, 100 processor cycles later, the in-order processor has retrieved the contents of the memory location pointed to by the memory address in register v1 and the contents are loaded to register v2. Instructions 3 and 4 are executed at processor cycle 101 and another cache memory miss occurs for instruction 3. Instruction 3 is also a load instruction and it similarly takes 100 processor cycles before the contents of the memory location pointed to by the memory address in register v4 can be retrieved and loaded to register v5. Instructions 5, 6 and 7 are executed in parallel at processor cycle 202 when instruction 3 is completed.

To allow an in-order processor to run ahead in its execution instead of stalling, hardware techniques have been proposed to uncover further cache misses in the execution of the code. The hardware techniques have often been referred to as load trolling. In load trolling, an additional bit is added to each register and a shadow register of each existing register is required. During load trolling, when the in-order processor encounters an instruction for which there is a cache memory miss, the execution of the current and later instruction groups in the code are not stalled. This may generate invalid data for the registers as the instructions are operating on data that may not yet be available. The registers with invalid data are marked by the additional bit. The shadow registers are required to copy the contents of each register before load trolling begins so that the registers are restored to the original, architecturally valid state from the point where the load trolling was started. However, implementing shadow registers for each register is an expensive feature as it takes up a lot of additional chip area.

### BRIEF DESCRIPTION OF THE DRAWINGS

The features and advantages of embodiments of the invention will become apparent from the following detailed description of the subject matter in which:

FIG. 1 illustrates a code sequence for an in-order processor (prior art);

FIG. 2 illustrates a software load trolling code sequence in accordance with one embodiment of the invention;

FIG. 3 illustrates a recovery routine in accordance with one embodiment of the invention;

FIG. 4 illustrates a flowchart of the operation of software load trolling in an in-order processor;

FIG. 5 illustrates a compiler in accordance with one embodiment of the invention; and

FIG. 6 illustrates a block diagram of a system to implement the methods disclosed herein according to an embodiment.

### DETAILED DESCRIPTION

Reference in the specification to “one embodiment” or “an embodiment” of the invention means that a particular feature, structure or characteristic described in connection with the embodiment is included in at least one embodiment of the invention. Thus, the appearances of the phrase “in one embodiment” appearing in various places throughout the specification are not necessarily all referring to the same embodiment.

Embodiments of the invention enable parallel and early execution of memory instructions in an in-order processor that are stalled by cache memory misses. The in-order processor handles cache memory misses of instructions in parallel by overlapping the first cache memory miss with cache memory misses that occur after the first cache memory miss. Memory-level parallelism can be increased in the in-order processor when more parallel and outstanding cache memory misses are generated. A cache memory includes, but is not limited to, a cache memory of any level such a Level 2 data cache (L2D) memory or Level 3 cache memory, a page table, a Translation Lookaside Buffer (TLB) cache memory, and any form of memory or storage device that can store the contents that is loaded into the input operand(s) of an instruction. An input operand of an instruction includes, but is not limited to, a source register that the instruction reads from.

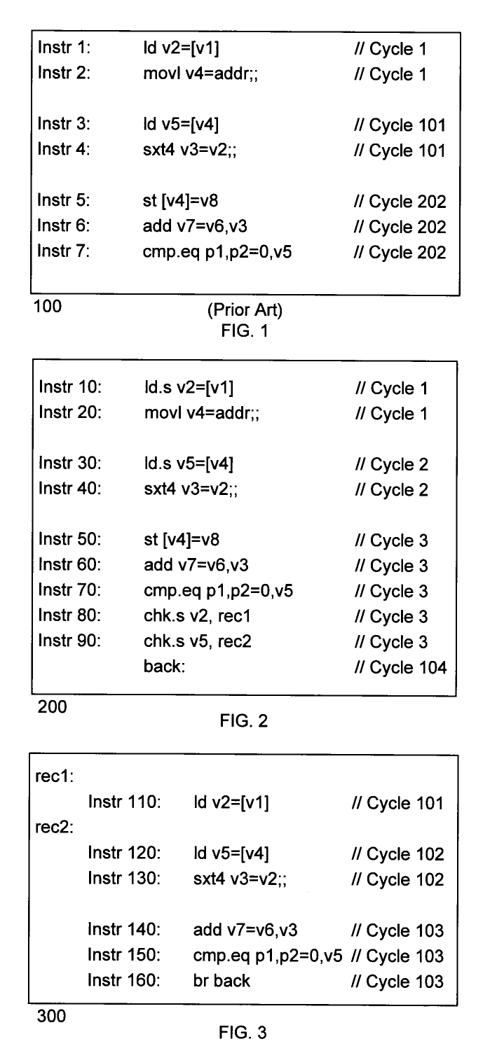

FIG. 2 illustrates an example of a software load trolling code sequence 200. The software load trolling code sequence 200 is a modification of the code sequence 100 as shown in FIG. 1 earlier. Load instructions in the code sequence 100 with a possibility of stalling the first use of its output operand(s) are replaced with control speculative load instructions. In code sequence 100, load instructions 1 and 3 are replaced with control speculative load instructions 10 and 30 respectively in software load trolling code sequence 200. An instruction with a possibility of stalling the first use of its output operand(s) includes, but is not limited to, a load instruction, and any other instruction that requires the in-order processor to retrieve the contents of the memory location pointed to by the memory address in the input operand(s) of the instruction.

In FIG. 2, control speculative load instruction 10 and instruction 20 are executed in parallel in processor cycle 1. Software load trolling initiates when there is a cache memory miss during the execution of control speculative load instruction 10. The output operand of control speculative load instruction 10 is set to an undefined value. The output operand of an instruction includes, but is not limited to, a target register that the instruction writes to. In one embodiment of the invention, the in-order processor sets the target register v2 of control speculative load instruction 10 as undefined during a cache memory miss when retrieving the contents of the memory location pointed to by the memory address in source register v1.

To enable the execution of the current and later instructions during a cache memory miss when retrieving the contents of the memory location pointed to by the memory address in the input operand(s) of a load instruction, an indicator associated with the output operand(s) of the load instruction is set to indicate that there is a cache memory miss when executing the load instruction. When the indicator is set, instructions that use the output operand(s) of the load instruction having a cache memory miss are allowed to execute. Unlike normal operation of processing instructions, the in-order processor does not stall on the first use of the output operand(s) of the load instruction when the load instruction encounters a cache memory miss when retrieving the contents of the memory location pointed to by the memory address in the input operand(s) of the load instruction during software load trolling. For example, the first use of the output operand(s) (target register v2) of control speculative load instruction 10 is instruction 40. Under normal operation of processing instructions, the in-order processor stalls the execution of instruction 40 until the contents of the memory location pointed to by the memory address in the output operand(s) (target register v2) of control speculative load instruction 10 is available. During software load trolling, instruction 40 is allowed to execute although with invalid input operands and the results of the execution are invalid.

In one embodiment, the indicator is an additional bit added to the target register. The additional bit is set when there is a cache memory miss. In one embodiment of the invention, the in-order processor is an Intel® Itanium® processor. The Intel® Itanium® processor has an extra bit called Not A Thing (NaT) bit on each of its general registers. A register NaT bit indicates whether the content of a register is valid. If the NaT bit is set to one, it typically indicates that the register contains a deferred exception token due to an earlier speculation fault. In one embodiment, the register NaT bit is modified to include the event of a cache memory miss of an instruction when the contents of the memory location pointed to by the memory address in the input operand(s) of the instruction are not available in the cache memory. The indicator may also be part of a scoreboard that logs the data dependencies of every instruction and indicates availability of the results of the instruction in another embodiment. If an instruction is stalled because its contents of the memory location pointed to by the memory address in the input operand(s) is not yet available due to a cache memory miss, the scoreboard indicates that the instruction is stalled and dependent instructions can execute with caution because the data may not be valid.

In FIG. 2, at processor cycle 1, control speculative load instruction 10 executes and determines that there is a cache memory miss when retrieving the contents of the memory location pointed to by the memory address in its input operand. Control speculative load instruction 10 continues to pre-fetch the contents of the memory location pointed to by the memory address in its input operand and sets an indicator associated with its output operand (target register v2). The output operand (target register v2) of control speculative load instruction 10 becomes available to other instructions when the indicator is set. Instruction 20 is also executed at processor cycle 1. At processor cycle 2, control speculative load instruction 30 and instruction 40 are executed in parallel notwithstanding the completion of control speculative load instruction 10. Instructions 30 and 40 are not stalled by the in-order processor because instruction 10 is a control speculative load instruction and the NaT bit of its output operand is set on a cache memory miss and its output operand is made available.

Control speculative load instruction 30 is independent of control speculative load instruction 10. It executes and determines that there is a cache memory miss when retrieving the contents of memory location pointed to by the memory address in source register v4. Control speculative load instruction 30 continues to pre-fetch the contents of the memory location pointed to by the memory address in its input operand and sets another indicator associated with its output operand (target register v5). Instruction 40 has an input operand that is dependent on the output operand (target register v2) of control speculative load instruction 10. Instruction 40 determines that the indicator associated with its input operand is set and executes in processor cycle 2 notwithstanding the completion of control speculative load instruction 10. In one embodiment, when one instruction reads an input operand(s) that has its indicator set, the output operands(s) of the instruction are also set. The indicators are propagated through dependent computations. Since instruction 40 is dependent on control speculative load instruction 10, the indicator associated with the output operand of instruction 40 is set after the execution of instruction 40.

In processor cycle 3, instructions 50, 60, 70, 80 and 90 execute in parallel. The input operand of instruction 50 is independent of any of the control speculative load instructions and the indicator associated with the output operand of instruction 50 is not set after its execution. Instruction 60 has an input operand that is dependent on the output operand (target register v3) of instruction 40. Since the indicator of the input operand of instruction 60 is set, the in-order processor sets the indicator associated with the output operand of instruction 60. Similarly, instruction 70 has an input operand that is dependent on the output operand (target register v5) of instruction 30. In one embodiment of the invention, predicate registers such as p1 and p2 also have an indicator to indicate that there is a cache memory miss. Since the indicator of the input operand of instruction 70 is set, the in-order processor executes instruction 70 and sets the indicator associated with the output operands of instruction 70.

Speculation check instructions 80 and 90 are added to the software load trolling code sequence 200 to determine the indicator setting of source registers v2 and v5 respectively. In instruction 80, when the indicator of source register v2 is set, a recovery routine rec1 is called. Similarly, in instruction 90, when the indicator of source register v5 is set, a recovery routine rec2 is called. It is noted that the speculation check instructions can also be performed on other target registers of the load trolling code sequence 200 because the indicator settings are propagated. For example, in instruction 80, the indicator setting of target register v3 can be checked instead of target register v2 because the indicator setting of target register v2 is propagated from control speculative load instruction 10 to the indicator setting of target register v3 in instruction 40.

FIG. 3 illustrates a recovery routine 300 that is called by the speculation check instructions 80 and 90. The recovery routine is executed if there are cache misses for the corresponding control speculative load instructions in the software load trolling code sequence 200. The recovery routine allows instructions that are executed notwithstanding the cache memory miss to be re-executed again because those instructions returned invalid data. As discussed earlier, control speculative load instructions 10 and 30 are executed and the contents of memory location pointed to by the memory address in source registers v1 and v4 are pre-fetched. 100 processor cycles later, the contents are retrieved. Instruction 110 executes the load instruction at processor cycle 101. At processor cycle 102, instructions 120 and 130 are executed. Instructions 120, 130, 140, 150 are inserted into the recovery routine because the indicator associated with each instruction may be set. In processor cycle 103, instructions 140 and 150 are executed and instruction 160 jumps back to the load trolling code sequence 200. At processor cycle 104, the flow reaches label back of the load trolling code sequence 200. The number of processor cycles used in the example is not meant to be limiting. For example, the number of cycles before the contents of the memory location pointed to by the memory address in the input operand(s) is retrieved can be greater or lesser than 100 processor cycles as assumed in the example.

In comparison with normal processing of instructions in the in-order processor that completes in 202 processor cycles in FIG. 1, the software load trolling code sequence 200 completes the same instructions in only 104 processor cycles. Since instructions can execute in parallel when a cache memory miss occurs, this improves the performance of the in-order processor by pre-fetching the contents of the memory location pointed to by the memory address in the input operand(s) of subsequent instructions that also experience cache memory misses. Memory-level parallelism can be achieved when memory instructions are executed in parallel when cache memory misses occur. Although the instructions in the load trolling code sequence 200 are illustrated in the same basic block, the instructions are not confined to basic blocks and can be extended across regions with arbitrary control flow without affecting the workings of the invention. Speculation check instructions can be positioned at the exits of the region with acyclic control flow. In other embodiments, the regions can also be extended across procedure boundaries or across functional calls.

The recovery routine in FIG. 3 is a unified recovery routine, i.e. both rec1 and rec2 are combined in the same recovery routine. Separate recovery routines can be created for each instruction that has a possibility of stalling the first use of its output operand(s) when retrieving the contents of the memory location pointed to by the memory address in the input operands(s) of each instruction. However, the recovery takes more time because multiple separate recovery routines need to be jumped to and executed sequentially. The main advantage of unified recovery code is that it reduces code size compared to separate recovery code. Even with this advantage, some code size increase is inevitable as the unified recovery code is added to the original code sequence. However, only the dynamic code size with its impact on the instruction cache efficiency matters for performance. In one embodiment, the recovery routine will be added into the cache memory only for regions where many costly cache memory misses occur, i.e., where there is a benefit from the technique that will likely offset the cost of increased dynamic code size.

If the larger dynamic code footprint impacts the performance of the in-order processor, a small dynamic runtime optimizer can be combined with the software load trolling. This optimizer detects program regions with frequent cache memory misses via Performance Monitoring Unit (PMU) sampling and modifies the spontaneous deferral bits in the opcodes of speculative loads in order to turn spontaneous deferral for these loads on or off. Spontaneous deferral refers to the setting of the indicator on a cache memory miss. In doing so, software load trolling would only be activated in “hot spots” with many costly cache memory misses where the benefit is most pronounced.

The technique is entirely backward compatible and does not require architecture extensions. On existing Intel® Itanium® processors that do not support the setting of NaT bits on a cache memory miss, the software load trolling code sequence 200 executes without performance penalty because the recovery routine 300 is not called on a cache miss. Due to the full architecture compliance, there are no complications resulting from context switches or interrupts for example.

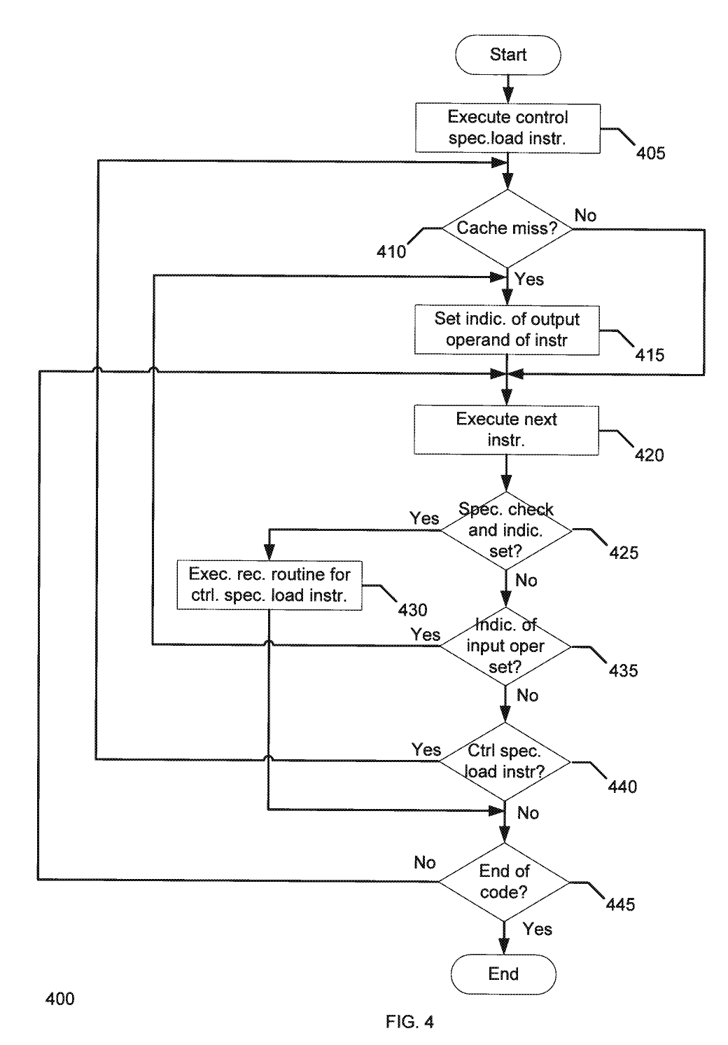

FIG. 4 illustrates a flowchart 400 of the operation of software load trolling in an in-order processor. In step 405, the in-order processor executes the first control speculative load instruction in a software load trolling sequence. Other instructions may have been executed prior to the execution of the first control speculative load instruction but are not shown in flowchart 400. Step 410 determines if there is a cache memory miss when the control speculative load instruction executed in step 405 is retrieving the contents of memory location pointed to by the memory address in its input operand. If yes, the indicator associated with the output operand(s) of the instruction is set in step 415. If no, the next instruction in the software load trolling sequence executes in step 420.

The flow goes to step 425 and it checks if the instruction executed in step 420 is a speculation check instruction and if the indicator of the output operand(s) checked in the speculation check instruction is set. If yes, the recovery routine for the corresponding control speculative load instruction is executed in step 430. If no, the flows goes to step 435 to check if the indicator associated with the input operand(s) of the instruction executed in step 420 is set. If yes, the flow goes back to step 415 to set the indicator associated with the output operand(s) of the instruction executed in step 420. If no, step 440 checks if the instruction executed in step 420 is a control speculative load instruction that is not dependent on the output operand(s) of the instruction executed in step 405. If yes, the flow goes back to step 410 to check if there is a cache memory miss. If no, the flow checks in step 445 if the end of the software load trolling code sequence has reached. Step 445 is also reached from step 430. If the end of the software load trolling code sequence has reached in step 445, the flow ends. If the end of the software load trolling code sequence has not reached in step 445, the flows goes back to step 420 to execute the next instruction. Flowchart 400 may also include multiple checks at the end of a software load trolling code sequence although it is not shown.

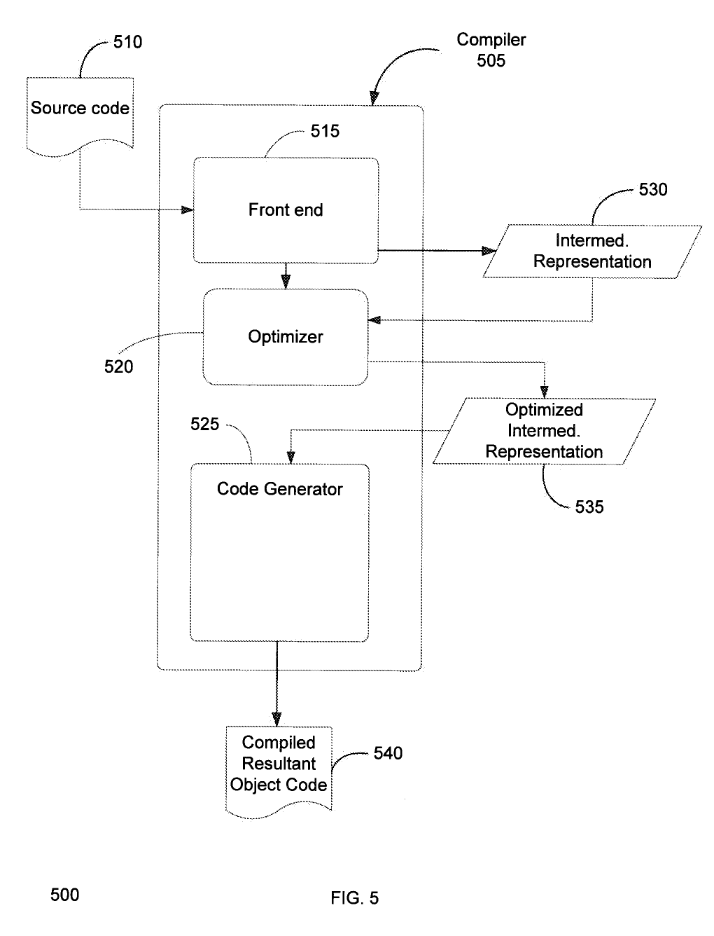

FIG. 5 illustrates a compiler 500 in accordance with one embodiment of the invention. Compiler 505 has a front end 515 to receive source code 510, an optimizer 520 to optimize Intermediate Representation (IR) form of the source code 510 and a code generator 525 to generate the compiled resultant object code 540. The front end 515 sends the received source code 510 to the IR block 530 and the IR block 530 converts the source code 510 into IR form. The IR block 530 sends the IR form to the optimizer 520 for optimization to produce an optimized IR form 535. The optimized IR form 535 is received by the code generator 525 and object code is generated by the code generator 525. The code generator 525 replaces each load instruction in the object code that may experience cache misses when executing in the in-order processor with a control speculative load instruction. The code generator 525 inserts speculation check instructions to determine the setting of indicators and also inserts the corresponding recovery code routines to re-execute instructions that has their associated indicators set.

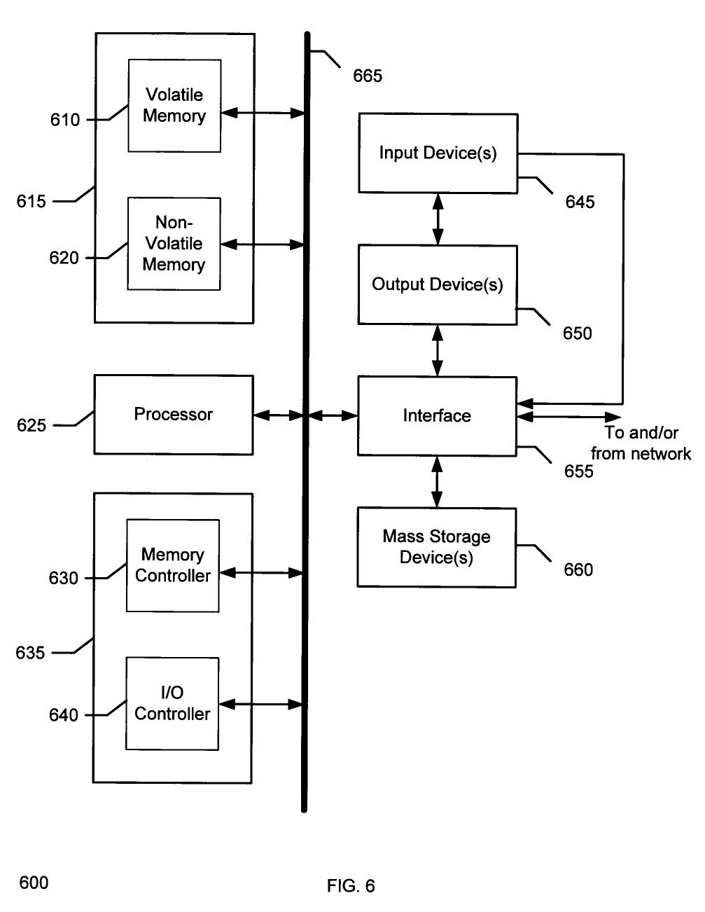

FIG. 6 illustrates a block diagram of a system 600 to implement the methods disclosed herein according to an embodiment. The system 600 includes but is not limited to, a desktop computer, a laptop computer, a notebook computer, a personal digital assistant (PDA), a server, a workstation, a cellular telephone, a mobile computing device, an Internet appliance or any other type of computing device. In another embodiment, the system 600 used to implement the methods disclosed herein may be a system on a chip (SOC) system.

The system 600 includes a chipset 635 with a memory controller 630 and an input/output (I/O) controller 640. A chipset typically provides memory and I/O management functions, as well as a plurality of general purpose and/or special purpose registers, timers, etc. that are accessible or used by a processor 625. The processor 625 may be implemented using one or more processors.

The memory controller 630 performs functions that enable the processor 625 to access and communicate with a main memory 615 that includes a volatile memory 610 and a non-volatile memory 620 via a bus 665.

The volatile memory 610 includes but is not limited to, Synchronous Dynamic Random Access Memory (SDRAM), Dynamic Random Access Memory (DRAM), RAMBUS Dynamic Random Access Memory (RDRAM), and/or any other type of random access memory device. The non-volatile memory 620 includes but is not limited by, flash memory, Read Only Memory (ROM), Electrically Erasable Programmable Read Only Memory (EEPROM), and/or any other desired type of memory device.

Memory 615 stores information and instructions to be executed by the processor 625. Memory 615 may also stores temporary variables or other intermediate information while the processor 625 is executing instructions.

The system 600 includes but is not limited to, an interface circuit 655 that is coupled with bus 665. The interface circuit 655 is implemented using any type of well known interface standard including, but is not limited to, an Ethernet interface, a universal serial bus (USB), a third generation input/output interface (3GIO) interface, and/or any other suitable type of interface.

One or more input devices 645 are connected to the interface circuit 655. The input device(s) 645 permit a user to enter data and commands into the processor 625. For example, the input device(s) 645 is implemented using but is not limited to, a keyboard, a mouse, a touch-sensitive display, a track pad, a track ball, and/or a voice recognition system.

One or more output devices 650 connect to the interface circuit 655. For example, the output device(s) 650 are implemented using but are not limited to, light emitting displays (LEDs), liquid crystal displays (LCDs), cathode ray tube (CRT) displays, printers and/or speakers). The interface circuit 655 includes a graphics driver card.

The system 600 also includes one or more mass storage devices 660 to store software and data. Examples of such mass storage device(s) 660 include but are not limited to, floppy disks and drives, hard disk drives, compact disks and drives, and digital versatile disks (DVD) and drives.

The interface circuit 655 includes a communication device such as a modem or a network interface card to facilitate exchange of data with external computers via a network. The communication link between the system 600 and the network may be any type of network connection such as an Ethernet connection, a digital subscriber line (DSL), a telephone line, a cellular telephone system, a coaxial cable, etc.

Access to the input device(s) 645, the output device(s) 650, the mass storage device(s) 660 and/or the network is typically controlled by the I/O controller 640 in a conventional manner. In particular, the I/O controller 640 performs functions that enable the processor 625 to communicate with the input device(s) 645, the output device(s) 650, the mass storage device(s) 660 and/or the network via the bus 665 and the interface circuit 655.

While the components shown in FIG. 16 are depicted as separate blocks within the system 600, the functions performed by some of these blocks may be integrated within a single semiconductor circuit or may be implemented using two or more separate integrated circuits. For example, although the memory controller 630 and the I/O controller 640 are depicted as separate blocks within the chipset 635, one of ordinary skill in the relevant art will readily appreciate that the memory controller 630 and the I/O controller 640 may be integrated within a single semiconductor circuit.

Although control speculative load instructions are described in various embodiments of software load trolling, the methods and systems disclosed herein apply to other long latency instructions which take a long time to produce a result. In one embodiment, a long latency instruction is an instruction that requires more than 5 processor cycles to complete. For example, in one embodiment, the methods and systems apply to a floating point (FP) instruction that takes a long time to execute when one of its input operands is special, such as a denormal number. The FP instruction can set the indicator associated with its output operand in order to enable software load trolling.

Although examples of the embodiments of the disclosed subject matter are described, one of ordinary skill in the relevant art will readily appreciate that many other methods of implementing the disclosed subject matter may alternatively be used. For example, the order of execution of the blocks in the flow diagrams may be changed, and/or some of the blocks in block/flow diagrams described may be changed, eliminated, or combined.

In the preceding description, various aspects of the disclosed subject matter have been described. For purposes of explanation, specific numbers, systems and configurations were set forth in order to provide a thorough understanding of the subject matter. However, it is apparent to one skilled in the relevant art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. A method of parallel execution of a first and a second instruction in an in-order processor comprising:
determining that the first instruction has a cache memory miss;
setting an indicator associated with an output operand of the first instruction, wherein the indicator indicates the cache memory miss; and
executing the second instruction responsive to the setting of the indicator notwithstanding the completion of the first instruction.

2. The method of claim 1, wherein the cache memory miss is a first cache memory miss, and the indicator is a first indicator, further comprising:
determining that the second instruction has a second cache memory miss; and
setting a second indicator associated with an output operand of the second instruction, wherein the second indicator indicates the second cache memory miss.

3. The method of claim 1, wherein the indicator is a first indicator, and wherein an input operand of the second instruction is dependent on an output operand of the first instruction, further comprising setting a second indicator associated with an output operand of the second instruction.

4. The method of claim 1 further comprising:
determining that the indicator is set; and
executing a recovery routine, wherein the recovery routine comprises executing the first and the second instructions.

5. The in-order processor of claim 1, wherein the in-order processor is an Intel® Itanium® processor.

6. The method of claim 5, wherein the first and the second indicator setting is a Not A Thing (NAT) bit setting of a first and a second target register executed upon by the first and the second instruction respectively, wherein the set NAT bit indicates the cache memory miss.

7. The method of claim 1, wherein the first instruction comprises a load instruction or a long latency instruction.

8. The method of claim 3, wherein the first and the second indicator setting is a part of a scoreboard that indicates availability of a first and a second target register executed upon by the first and the second instruction respectively.

9. The method of claim 1, wherein the cache memory is a cache memory at any level or a Translation Lookaside Buffer (TLB) cache memory.

10. A compiler to generate object code for an in-order processor comprising:
a front end to receive source code;
a Intermediate Representation (IR) block, coupled with the front end, to convert the source code into IR form; and
a code generator, coupled to the IR block to:
compile the IR into the object code;
replace an instruction in the object code with a control speculative load instruction, wherein the instruction has a possibility of stalling a first use of an output operand of the instruction when executing in the in-order processor, and wherein the control speculative load instruction is to:
determine that the instruction has a cache memory miss; and
set an indicator associated with the output operand of the instruction, wherein the indicator indicates the cache memory miss;
insert a speculation check instruction to determine the indicator setting; and
insert a recovery routine, wherein the recovery routine comprises executing the instruction.

11. The code generator of claim 10, wherein the instruction is a first instruction, and wherein the recovery routine further comprises:
executing a second instruction, wherein an input operand of the second instruction is reliant on the output operant of the first instruction.

12. The compiler of claim 10, wherein the in-order processor is an Intel® Itanium® processor.

13. The compiler of claim 12, wherein the setting is a Not A Thing (NAT) bit setting of a target register executed upon by the instruction, wherein the set NAT bit indicates the cache memory miss.

14. The compiler of claim 10, wherein the instruction comprises a load instruction or a long latency instruction.

15. The compiler of claim 10, wherein the indicator setting is a part of a scoreboard that indicates availability of a target register executed upon by the instruction.

16. The compiler of claim 10, wherein the cache memory is a cache memory at any level or a Translation Lookaside Buffer (TLB) cache memory.

17. A computer readable medium having instructions stored thereon which, when executed, cause an in-order processor to perform the following method:
determining that the first instruction has a cache memory miss;
setting an indicator associated with an output operand of the first instruction, wherein the indicator indicates the cache memory miss; and
executing the second instruction responsive to the setting of the indicator notwithstanding the completion of the first instruction.

18. The medium of claim 17, wherein the cache memory miss is a first cache memory miss and the indicator is a first indicator, further comprising:
determining that the second instruction has a second cache memory miss; and
setting a second indicator associated with an output operand of the second instruction, wherein the second indicator indicates the second cache memory miss.

19. The medium of claim 17, wherein the indicator is a first indicator, and wherein an input operand of the second instruction is dependent on an output operand of the first instruction, further comprising setting a second indicator associated with an output operand of the second instruction.

20. The medium of claim 17 further comprising:
determining that the first indicator is set; and
executing a recovery routine, wherein the recovery routine comprises executing the first and the second instructions.

21. The medium of claim 17, wherein the in-order processor is an Intel® Itanium® processor.

22. The medium of claim 21, wherein the first and the second attribute setting is a Not A Thing (NAT) bit setting of a first and a second target register executed upon by the first and the second instruction respectively, wherein the set NAT bit indicates the cache memory miss.

23. The medium of claim 17, wherein the first instruction comprises a load instruction or a long latency instruction.

24. The medium of claim 17, wherein the first and the second attribute setting is a part of a scoreboard that indicates availability of a first and a second target register executed upon by the first and the second instruction respectively.

25. The medium of claim 17, wherein the cache memory is a cache memory at any level or a Translation Lookaside Buffer (TLB) cache memory.
